(19) United States
(12) Patent Application Publication
(10) Pub. No.: US 2022/0036268 A1
(43) Pub. Date: Feb. 3, 2022

(54) Providing Financial Services to Unserved and Underserved Areas

(71) Applicant: Wells Fargo Bank, N.A., San Francisco, CA (US)

(72) Inventors: H. Brock Kolls, Alpharetta, GA (US); Chhanda Charan Patanaik, Bangalore (IN); Timothy A. Gates, Ewing, NJ (US); Merle D. Wait, JR., Watauga, TX (US)

(21) Appl. No.: 15/728,259

(22) Filed: Oct. 9, 2017

(51) Int. Cl. G06Q 10/06; G06Q 40/02; G05D 1/00; G08G 1/00

(52) U.S. Cl. CPC G06Q 10/06314; G06Q 40/02; G05D 2201/0213; G08G 1/202; G05D 1/0088

(57) ABSTRACT

A method for matching financial services to locations includes identifying one or more locations which are unserved or underserved regarding financial services. A set of the financial services that could be applicable at one of the one or more locations is determined. A set of technologies needed to implement the set of financial services is determined. A vehicle that contains the set of technologies is identified. The vehicle is directed to the one of the one or more locations.

### BACKGROUND

Financial institutions such as banks are ubiquitous in highly populated areas of the United States. Individuals living in these highly populated areas, for example large metropolitan areas, can typically have their choice of a variety of banks and other financial services companies to handle their financial needs.

In other areas of the United States, financial institutions are often not as readily available. Individuals living in small cities and smaller metropolitan areas typically do not have as many choices regarding financial institutions as those individuals living in large metropolitan areas. Some rural areas may not have any local banks or other financial institutions.

### SUMMARY

Embodiments of the disclosure are directed to a method implemented on an electronic computing device for matching financial services to locations. The method comprises: identifying one or more locations which are unserved or underserved regarding financial services; determining a set of the financial services that could be applicable at one of the one or more locations; determining a set of technologies needed to implement the set of financial services; identifying a vehicle that contains the set of technologies; and directing the vehicle to the one of the one or more locations.

In another aspect, a method implemented on an electronic computing device for providing financial services to one or more geographical locations comprises: identifying one or more geographical locations that are unserved or underserved regarding the financial services; identifying one or more categories of the financial services that are applicable to a community at one of the one or more geographical locations; and directing a mobile banking vehicle that is equipped with at least one of an ATM machine, an optical scanner and a video conferencing capability to the one of the one or more geographical locations.

In yet another aspect, a server computing device comprises: a processing unit; and system memory, the system memory including instructions which, when executed by the processing unit, cause the server computing device to: identify one or more geographical locations that are unserved or underserved regarding financial services; identify a set of the financial services that could be applicable at one of the one or more geographical locations; identify a set of technologies needed to implement the set of financial services at the one of the one or more geographical locations, the set of technologies including optical scanning and video conferencing; identify an autonomous vehicle that includes the set of technologies needed at the one of the one or more geographical locations; determine a date and time for when the autonomous vehicle is needed at the one of the one or more geographical locations; and direct the autonomous vehicle that is equipped with the set of technologies to arrive at the one of the one or more of the geographical locations at the date and time for when the autonomous vehicle is needed at the one of the one or more geographical locations.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports providing financial services to unserved and underserved areas.

FIG. 2 shows example modules of the financial services engine of the server computing device of FIG. 1.

FIG. 3 shows an example method for providing financial services to unserved and underserved areas.

FIG. 4 shows additional example details of one operation of the method of FIG. 3.

FIG. 5 shows example physical components of the server computing device of FIG. 1.

### DETAILED DESCRIPTION

The present disclosure is directed to systems and methods for identifying areas in the United States of America for which financial services may be limited or non-existent and providing mobile financial services to these areas. The mobile financial services can be provided via vehicles that can include technology for the specific financial services needed in an area. The financial services that can be provided by the vehicles can include check cashing services, automated teller machines (ATMs), full-service banking and other financial services. The systems and methods can also be used in areas of the world other than the United States.

Using the systems and methods, the financial services can be provided for a plurality of situations. The situations can include rural areas that are unserved or underserved regarding financial services and parts of metropolitan areas that may be unserved or underserved. The systems and methods can also be used for special situations such as pay-day check cashing, special events such as football games or other public gatherings where additional financial services, such as ATMs, may be needed, retirement communities where retirees may be limited in their mobility to reach traditional financial institutions, and other similar situations.

The systems and methods can also be used for strategic communities, such as communities that may be already be served by one or more financial institutions, but not by a financial institution offering the mobile financial services. The financial institution may decide that it would be beneficial to gain a presence in the strategic communities. By offering the mobile financial services to the strategic communities, the financial institution can gain a presence in the strategic communities and attempt to build loyalty to the financial institution among residents of the strategic communities.

The unserved and underserved areas can be identified via individuals in the unserved and underserved areas and via a computer software application than can identify the unserved and underserved areas. The computer software application can receive inputs from a variety of sources, including employees of a financial institution, social media sources, news services, research data and other sources.

Once the areas are identified, financial needs for an area can be identified and financial services can be matched to the needs. Technology appropriate for servicing the needs can be identified and the technology can be incorporated into one or more vehicles, such as a mobile bank. The vehicles can be linked to a closest retail office of the financial institution to provide additional support, if needed. The vehicles can then be scheduled to deliver the financial services at specific times and locations.

In this disclosure, the mobile vehicle and the delivery of financial services are described for a bank. However, the systems and methods can also be used for other financial institutions, such as investment services companies and mortgage companies.

The systems and methods disclosed herein are directed to a computer technology that can identify geographical areas that are unserved or underserved regarding financial services. The systems and methods can also identify a set of financial services that are needed at the geographical areas. In addition, the systems and methods can determine which technologies need to be incorporated in a mobile facility to implement the set of financial services. Further, the systems and methods can determine a schedule of dates and times for when the mobile facility is needed and direct the mobile facility to an unserved or underserved area when the mobile facility is need at the unserved or underserved area.

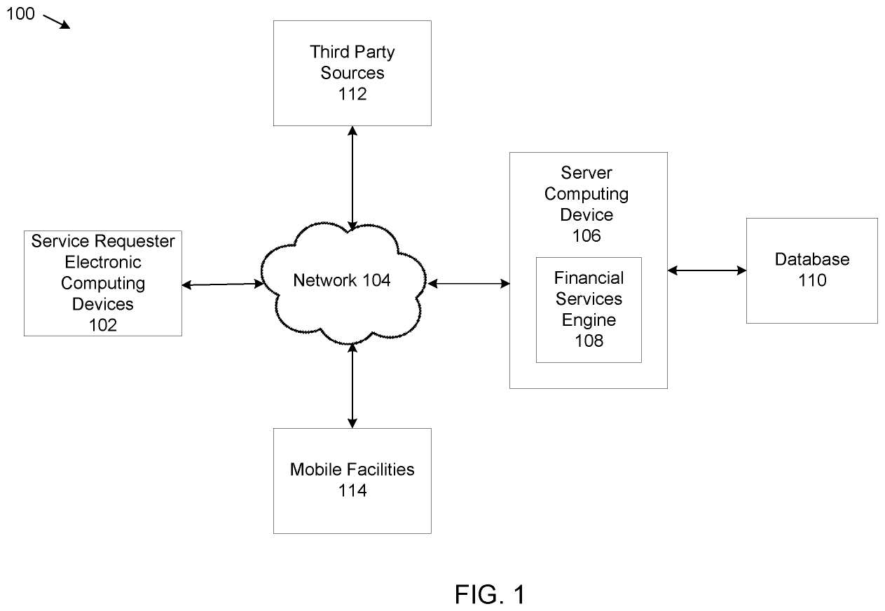

FIG. 1 shows an example system 100 that can support providing financial services to unserved and underserved areas. System 100 includes service requester electronic computing devices 102, a network 104, a server computing device 106, a database 110, third party sources 112 and mobile facilities 114. Server computing device 106 includes a financial services engine 108. More, fewer or different components are possible.

The example service requester electronic computing devices 102 are electronic computing device of individuals who can make a request of the financial institution for mobile financial services or who can provide information to the financial institution regarding unserved and underserved areas. For example, an individual can be someone who lives in an unserved or underserved area, an employee of the financial institution or any other person who may make a request for mobile financial services or who can provide the information regarding the unserved and underserved areas. The electronic computing device can be one of a desktop computer, laptop computer, tablet computer or smartphone. Other electronic computing devices are possible.

The example network 104 is a computer network such as the Internet. Service requester electronic computing devices 102, third party sources 112 and mobile facilities 114 can communicate with server computing device 106 using network 104.

The example server computing device 106 is a server computing device of a financial institution such as a bank. The financial institution can provide a plurality of financial services including checking and savings accounts, personal loans, mortgages, personal banking advisors, check cashing and other financial services.

The example financial services engine 108 is a software application that can implement aspects of providing financial services to unserved and underserved areas. The financial services engine 108 can identify areas of the United States that may be in need of financial services. Once the areas are identified, financial services engine 108 can match the identified areas with financial services that may be needed in the identified areas and that can be provided via a mobile facility, such as a mobile banking vehicle.

Financial services engine 108 can also identify a retail branch of the financial institution that is close to each of the identified areas and that can provide additional support to the mobile facility. For example, the retail branch can provide a personal banker or credit consultant that can communicate with a customer of the mobile facility via video conferencing.

Financial services engine 108 can also identify technology needed for providing the financial services, assign mobile vehicles with the needed technology to specific areas and schedule delivery of the mobile vehicles at specific dates and times. Financial services engine 108 is discussed in more detail later herein.

The example database 110 is a database associated with the financial institution. Database 110 can store information regarding customers of the financial institution and information regarding the unserved and underserved areas. Database 110 can be distributed over a plurality of databases. Financial services engine 108 can be programmed to query (e.g. using SQL) database 110 to obtain the customer information, the information regarding the unserved and underserved areas and other information.

Database 110 can also store information regarding unserved and underserved areas. For example, the financial institution can conduct research regarding the unserved and underserved areas and store the results of the research in database 110. An example schema of information stored in database 110 regarding the unserved and underserved areas is shown below:
Name of area
Location (region, state, city)
Description
Status Flag (Unserved, Underserved)
Events (description, type, date, time, frequency)
Financial Institution Presence (yes, no)

The above example schema permits the database to be queried for one or more aspects of the underserved and underserved areas. For example queries can be performed by region, state and city, by a description, whether a location is unserved or underserved, by specific events by a type of event and whether the financial institution has a presence at the location. Example descriptions can include rural area, small town, metropolitan area and retirement community. Example event types can include, sporting event and payday. Other descriptions and event types are possible.

The example third party sources 112 are electronic computing devices, for example server computing devices and databases from a variety of sources that can provide information that can help identify the unserved and underserved areas. Example third party sources can be server computing devices from news organizations, local governments, social media sources and web sites with information about rural communities. Other third party sources are possible.

The example mobile facilities 114 are vehicles that can include technology that can provide mobile financial services to individuals in the unserved and underserved areas. One example of mobile facilities 114 is a mobile banking vehicle. The technology can include items such as optical scanners and readers, ATMs, video conferencing and other technology. In one example implementation, the mobile facilities 114 can be autonomous vehicles. Financial services engine 108 can direct the autonomous vehicles to the unserved and underserved areas as needed. In some implementations, the autonomous vehicles can include one or more employees of the financial institution to help interface with customers. In other implementations, for example when only ATM service is needed, the autonomous vehicles can be dispatched without any humans.

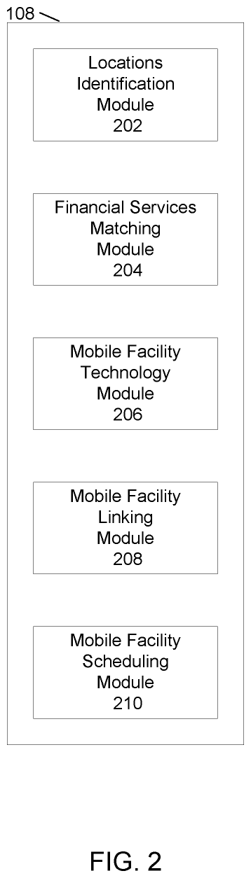

FIG. 2 shows example modules of financial services engine 108. Financial services engine 108 can include a locations identification module 202, a financial services matching module 204, a mobile facility technology module 206, a mobile facility linking module 208 and a mobile facility scheduling module 210. More, fewer or different modules are possible.

The example locations identification module 202 identifies unserved and underserved areas of the United States that have financial needs that can be serviced by the financial institution. As discussed earlier herein, the unserved and underserved areas can be one or more of rural areas, small cities, areas of larger cities and locations for which an event, such as a football game, may be occurring. The financial needs can include check cashing, ATMs and full-service banking.

Locations identification module 202 can identify the unserved and underserved areas in several ways. For example, locations identification module 202 can obtain information from database 110 and from one or more third party sources 112 regarding the locations of banks within the United States. Using the information regarding the locations of the banks, geographical areas that do not have banks within a reasonable distance can be identified.

Locations identification module 202 can also identify geographical areas for which financial services such as banking may already be provided but in which the financial institution does not have a physical presence. The financial institution can decide that it is worthwhile to provide mobile banking to these areas so that the financial institution can be competitive with other financial institutions in the area.

Locations identification module 202 can also identify other opportunities for mobile banking. One such opportunity can be to provide mobile banking services to retirement communities. The areas in which the retirement communities are located may already have facilities that provide financial services, but because many elderly residents of the retirement communities do not drive or may not have easy access to the retirement communities, there could be a need for mobile banking services.

In addition, locations identification module 202 can obtain information from third party sources 112 regarding special events for which there could be a need for mobile banking services. Example special events can include football games and other entertainment events, for example where attendees may need additional access to ATM machines and paydays at factories or other businesses where employees may need help cashing checks. Other special events are possible.

Locations identification module 202 can also obtain information regarding population density of the identified areas and made a determination as to whether mobile banking would be desirable in the identified areas and whether providing mobile banking to these areas would be profitable to the financial institution.

The example financial services matching module 204 matches identified areas in need of banking services with financial services that are needed in the identified areas. Examples of financial services that may be needed can include check cashing, ATMs, checking and savings accounts and full-service banking. Full-service banking can include loans, mortgages and access to personal bankers. Other financial services are possible.

In addition, retail branches of the financial institution can be associated with the identified areas to provide support for the needed services. The retail branches are generally those that are the closest to the identified areas, even though they may be located many miles away, that have technology and/or personal that can supplement the mobile banking vehicles. For example, a retail branch could have a credit consultant with whom a customer in one of the identified areas may wish to consult.

The example mobile facility technology module 206 identifies technology needed to support mobile banking services for an identified area. Examples of technology that may be needed can include an optical scanner and video conferencing. Mobile facility technology module 206 can also access available mobile banking vehicles and identify any available mobile banking vehicles that contain the needed technology. When available mobile banking vehicles do not contain the needed technology, mobile facility technology module 206 can initiate a process to have an available mobile banking vehicle retrofitted or configured with the needed technology.

The example mobile facility linking module 208 provides a link from a mobile banking vehicle at an identified area to a close retail branch of the financial institution. The retail branch is typically one that is closest to the identified area and that provides support for financial services needed at the identified area. For example, the retail branch can maintain a supply of funds and service material needed by the mobile banking vehicle. As another example, if a customer needs to speak to a live person while using the mobile banking vehicle at the identified area, the mobile banking vehicle can establish a video conference with the live person, for example a personal banker, at the retail branch. The mobile facility linking module 208 can identify the retail branch and communicate the identity of the retail branch to the mobile banking vehicle.

The example mobile facility scheduling module 210 schedules available mobile facilities of the financial institution to the areas identified as being in need of the mobile facilities. Mobile facility scheduling module 210 can receive input from locations identification module 202 as to identified areas at which mobile facilities are needed and to the dates and times of specific events that may be occurring at one or more of the identified areas. For example, locations identification module 202 can provides the dates and times of football games or other events at which a mobile banking vehicle is needed. As another example, individuals at some identified areas may want to have a mobile facility in their area at the same time every day, so the individuals can rely on the mobile facility being there. Mobile facility scheduling module 210 can schedule the mobile facility to be at the required identified area at a specific time every day.

Mobile facility scheduling module 210 can also schedule the same mobile facility for multiple tasks. For example, a mobile facility can be sent to an underserved community and then on payday at a specific date and time, the mobile facility can be moved to a nearby business (e.g. a factory) where the mobile facility can be used to cash checks for the employees.

There can be various technical advantages associated with the systems and method described herein. For example, server computing device 106 can be optimized to identify unserved and underserved geographical areas, identify a set of financial services and supporting technologies that are appropriate for the unserved and underserved geographical areas and identify and schedule mobile facilities for these areas to provide the needed financial services when they are needed. This can result in a system that processes fewer requests for financial services, because needs for financial services are handled in advance, and can result in more efficient scheduling of mobile facilities, because mobile facilities with the proper supporting technologies are more likely to be scheduled correctly. This can result in an overall system that is faster, uses less computing power and is able to support a larger number of unserved and underserved areas.

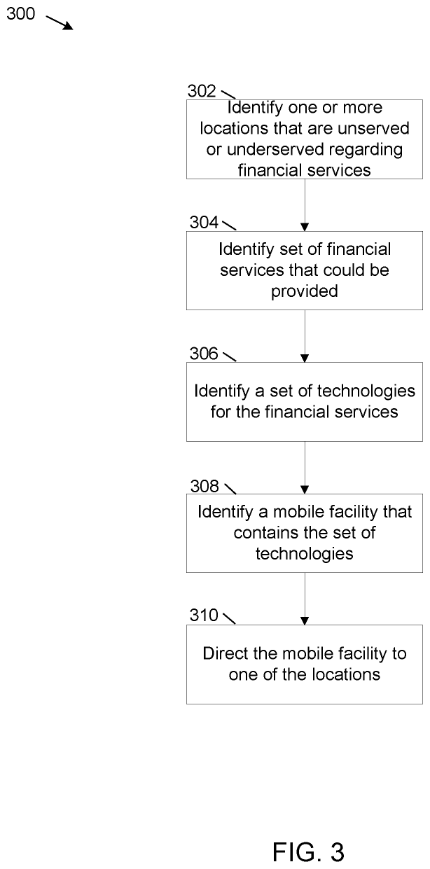

FIG. 3 shows a flowchart for an example method 300 implemented on an electronic computing device, for example on server computing device 106, to provide financial services to unserved and underserved areas. The unserved and underserved areas can be geographical locations in the United States and the world in which financial services are not being provided or to which the financial services provided do not meet all the needs of the people at the geographical locations. The unserved and underserved areas can also include geographical locations at which financial services may be needed for an event, such as at a sporting event, to cash checks for employees at payday or at other events.

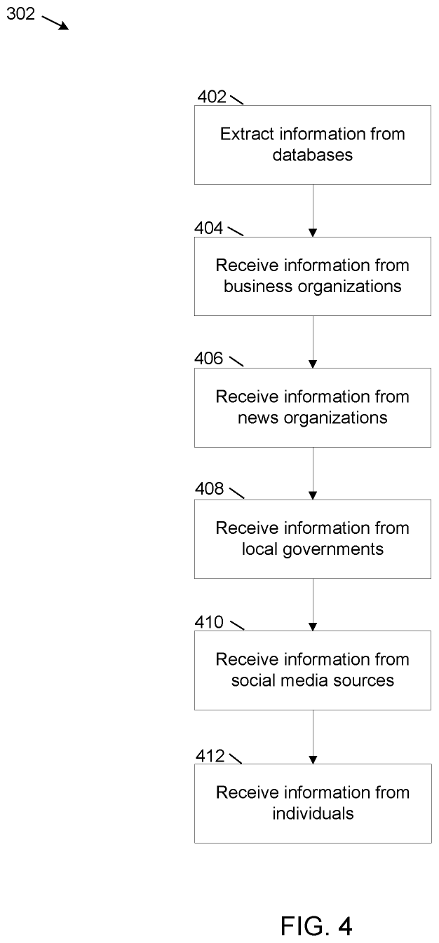

At operation 302, one or more locations are identified that are unserved or underserved regarding financial services, for example banking services. The locations can be identified from one or more of information extracted from databases, information received from business organizations, information received from news organizations, information received from local governments, information received from social media sources and information received from individuals. These sources of information are described in more detail later herein with respect to FIG. 4. Other sources of information are possible.

At operation 304, a set of financial services that could be provided to customers at the unserved or underserved locations are identified. The set of financial services can include one or more of check cashing, check depositing, cash dispensing (for example via ATMs), opening of checking and savings accounts and full-service banking.

The set of financial services that could be provided are dependent on the nature of the unserved or underserved area. For example, when the area is a rural area with no nearby access to financial services, full-service banking may be appropriate. When the area is a retirement community in which many of the residents have limited mobility, full-service banking may also be appropriate. When the area is a location of an event such as a football game, in which attendees would like to have convenient cash access, an ATM could be appropriate. When the area is a location of a business, such as a factory, check cashing functionality may be all that is needed.

At operation 306, a set of technologies are identified to support the identified set of financial services from operation 304. The technologies can include items such as document scanners, ATMs, video conferencing, cameras for taking photo IDs, finger print scanners, retinal scanners, security cameras and other items.

As an example of a use of a set of technologies to support the set of financial services from operation 304, when the set of financial services includes check cashing, the set of technologies can include a document scanner to scan in the check and to verify that the check has been properly endorsed. An ATM can also be provided to receive the check and dispense cash for the amount of the check. As another example, when the set of financial services includes the opening of checking and savings accounts, the set of financial services can include cameras for taking photo IDs and one or more of finger print scanners and retinal scanners to verify an identity of the individual requesting the checking or savings account. As yet another example, when the set of financial services include full-service banking, the set of technologies can include the document scanners, ATMs, finger prints scanners and retinal scanners, as discussed above. In addition, the set of technologies can also include video conferencing and security cameras. The video conferencing can be used, for example, to establish a video communication session with a personal banker, for example when the personal banker is not physically at the underserved or unserved location. Additionally, when the personal banker is physically at the underserved or unserved location, video conferencing can be used to establish a video communication session with a financial specialist, such as a mortgage banker or an investment advisor who may be at a different location from the underserved or unserved location. Other examples are possible.

At operation 308, one or more mobile facilities are identified that contain the set of technologies needed to support the identified financial services. For method 300, the mobile facilities comprise mobile banking vehicles. When a determination is made that there aren't any mobile facilities that contain the needed technologies, an existing mobile facility is reconfigured to include the needed technologies. Alternatively, a mobile facility can be acquired.

At operation 310, the mobile facility is directed to one of the locations identified in operation 302. For method 300, server computing device 106 directs the mobile facility to one of the locations on a date and time determined by mobile facility scheduling module 210.

The direction of the mobile facility to the one or more locations at operation 310 can include both the direction of a human-driven mobile facility and the direction of an autonomous (self-driving) mobile facility. When the mobile facility is human driven, the direction can comprise sending instructions to a smart-phone of the driver of the mobile facility. The instructions can include one or more locations to which the mobile facility is to be driven and route directions to the one or more locations. When the driver is already out on the road with the mobile facility, the instructions can include changes to the driver's itinerary to add one or more additional stops. When the mobile facility comprises an autonomous vehicle, the direction can include sending instructions to a fleet management server computing device (for example one of third party sources 112) to initiate or redirect the mobile facility to the one or more locations to which the mobile facility is to be driven.

In an example use case of method 300, a geographical location can be identified in which ATM machines for the financial institution are not available. For example, a small city may have one or more branch offices of the financial institution, but none of the branch offices has ATM machines. The financial institution can determine that it would be beneficial to provide a mobile facility that includes an ATM machine at selected locations in the small city. For example, the mobile facility can be scheduled to be at each of the branch offices in the small city at a specific day and time. Customers of the financial institution can then access the ATM at their branch office at the day and time when the mobile facility is scheduled to be at the branch office.

In another example use case of method 300, through surveys, customer requests or other means, the financial institution can determine that it could be beneficial for the financial institution and for customers of the financial institution to provide a check cashing service at a business facility, for example a factory, where workers are paid each Friday. For example, the closest branch office of the financial institution may be a long distance from the location of the factory. By providing a mobile facility with check cashing functionality at the factory when the workers are paid, the workers can benefit by not having to travel the long distance to the branch office in order to cash their checks and the financial institution can benefit by helping their customers and by advertising their services to non-customer workers who could be potential new customers.

FIG. 4 shows a flowchart for the example operation 302 of FIG. 3 for identifying one or more locations that are unserved or underserved regarding financial services.

At operation 402, information regarding unserved and underserved areas is extracted from a database, for example database 110, of the financial institution. For example, database 110 may store the results of research by the financial institution regarding unserved and underserved communities and regarding events that may require financial services in the unserved and underserved communities. The information that is extracted from the database can be as a result of a query of the database for specific information, such as for a list of unserved and underserved communities in a particular geographical area, such as a state or region.

At operation 404, information regarding unserved and underserved areas is received from business organizations. The business organizations, one of third party sources 112, can include research organizations that the financial institution can hire to conduct research regarding unserved and underserved areas and any other business in communication with the financial institution than can provide any information regarding unserved and underserved areas.

At operation 406, information is received from news organizations, one of third party sources 112, regarding unserved and underserved areas. In some implementations, the news organizations can be hired by the financial institution to filter out the information regarding the unserved and underserved areas and provide this information to server computing device 106. In other implementations, server computing device 106 can obtain news feeds from the news organizations and locations identification module 202 can filter the news feeds to obtain any relevant information regarding unserved and underserved areas, including news about events in these areas.

At operation 408, information is received from local governments, one of third party sources 112, regarding unserved and underserved areas. For example, a small city in an area identified as an unserved or underserved area may announce an event, for example a parade that could provide an opportunity for the financial institution to provide an ATM machine in a mobile facility. The locations identification module 202 can receive and parse the announcement and determine whether the use of the mobile facility is warranted. Other examples are possible.

At operation 410, information is received from social media sources, one of third party sources 112, regarding unserved and underserved areas. For example the financial institution can have access to Twitter feeds and other social media sites that may identify locations in need of financial services and that can provide information regarding unserved or underserved areas.

At operation 412, information regarding unserved and underserved areas is received from individuals. The individuals can provide the information from one of service requester electronic computing devices 102. For example, some individuals can be employees of the financial institution who can have information regarding the unserved and underserved areas. Other individuals can be customers of the financial institution who can have information regarding events at an unserved or underserved area. Other individuals can be non-customers of the financial institution who may reside in or nearby an unserved and underserved area and may wish to contact the financial institution regarding the unserved and underived area. For example, the individuals may access a web page hosted on server computing device 106 that permits inputs and suggestions from individuals. The individuals can also request that the financial institution provide financial services in the area in which they reside. Locations identification module 202 can monitor the website and obtain pertinent information.

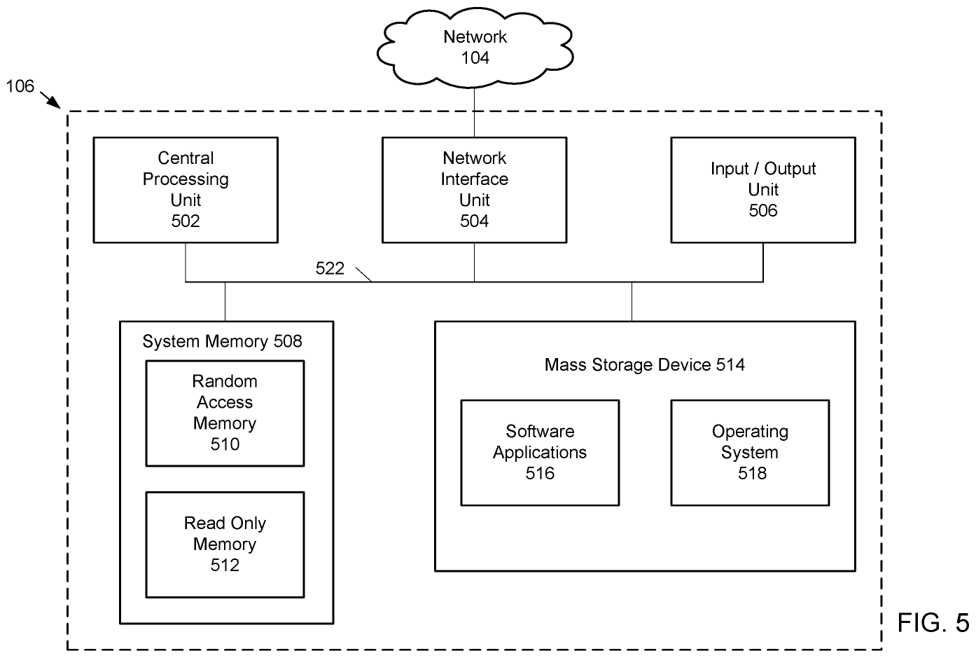

As illustrated in the example of FIG. 5, server computing device 106 includes at least one central processing unit (“CPU”) 502, also referred to as a processor, a system memory 508, and a system bus 522 that couples the system memory 508 to the CPU 502. The system memory 508 includes a random access memory (“RAM”) 510 and a read-only memory (“ROM”) 512. A basic input/output system that contains the basic routines that help to transfer information between elements within the server computing device 106, such as during startup, is stored in the ROM 512. The server computing device 106 further includes a mass storage device 514. The mass storage device 514 is able to store software instructions and data. Some or all of the components of the server computing device 106 can also be included in service requester electronic computing devices 102.

The mass storage device 514 is connected to the CPU 502 through a mass storage controller (not shown) connected to the system bus 522. The mass storage device 514 and its associated computer-readable data storage media provide non-volatile, non-transitory storage for the server computing device 106. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server computing device 106.

According to various embodiments of the invention, the server computing device 106 may operate in a networked environment using logical connections to remote network devices through the network 104, such as a wireless network, the Internet, or another type of network. The server computing device 106 may connect to the network 104 through a network interface unit 504 connected to the system bus 522. It should be appreciated that the network interface unit 504 may also be utilized to connect to other types of networks and remote computing systems. The server computing device 106 also includes an input/output controller 506 for receiving and processing input from a number of other devices, including a touch user interface display screen, or another type of input device. Similarly, the input/output controller 506 may provide output to a touch user interface display screen or other type of output device.

As mentioned briefly above, the mass storage device 514 and the RAM 510 of the server computing device 106 can store software instructions and data. The software instructions include an operating system 518 suitable for controlling the operation of the server computing device 106. The mass storage device 514 and/or the RAM 510 also store software instructions and software applications 516, that when executed by the CPU 502, cause the server computing device 106 to provide the functionality of the server computing device 106 discussed in this document. For example, the mass storage device 514 and/or the RAM 510 can store software instructions that, when executed by the CPU 502, cause the server computing device 106 to display received data on the display screen of the server computing device 106.

Although various embodiments are described herein, those of ordinary skill in the art will understand that many modifications may be made thereto within the scope of the present disclosure. Accordingly, it is not intended that the scope of the disclosure in any way be limited by the examples provided.

1. A method implemented on an electronic computing device for matching financial services to locations, the method comprising:
identifying one or more locations which are unserved or underserved regarding financial services using information received from one or more databases regarding current locations of financial institutions in a geographical area, including:
querying the one or more databases for aspects of the one or more locations, the aspects including:
(i) types of events at the one or more locations;
(ii) times of the events at the one or more locations; and
(iii) frequency of the events at the one or more locations; and
determining a set of the financial services to provide at one of the one or more locations based on an event type at each of the one or more locations, including determining a first set of the financial services when the event type is a payday for employees of a business at the one of the one or more locations, and including determining a second set of financial services when the event type is a sporting event at the one of the one or more locations, the first set and the second set being different from each other;
identifying a set of technologies needed to implement the determined set of financial services;
configuring the vehicle to include the identified set of technologies; and
autonomously driving the configured vehicle to the one of the one or more locations.

2. The method of claim 1, further comprising:
identifying a specific date and time for which the financial services are needed at the one of the one or more locations; and
directing the vehicle to the one of the one or more locations at the specific date and time.

3. The method of claim 1, wherein the one or more locations include rural areas that are unserved regarding the financial services.

4-6. (canceled)

7. The method of claim 1, wherein one of the one or more locations is at or near a retirement community and the financial services are directed to residents of the retirement community.

8. (canceled)

9. The method of claim 1, wherein the vehicle includes technologies of an automatic teller machine (ATM) and an optical reader.

10. The method of claim 1, wherein the vehicle includes video-conferencing.

11. The method of claim 1, wherein the vehicle includes functionality for full-service banking.

12. The method of claim 1, further comprising:
identifying a retail branch of a financial institution that supports the set of technologies and that is a closest to the one of the one or more locations; and
creating a link between the retail branch and the vehicle.

13. The method of claim 1, further comprising receiving information from one or more sources identifying at least one of the one or more locations that may need the financial services.

14-19. (canceled)

20. A server computing device, comprising:
a processor; and
system memory, the system memory including instructions which, when executed by the processor, cause the server computing device to:
use information received from one or more databases regarding current locations of financial institutions in a geographical area to identify one or more geographical locations that are unserved or underserved regarding financial services, the use information including:
query the one or more databases for aspects of the one or more geographical locations, the aspects including:
(i) types of events at the one or more geographical locations;
(ii) times of the events at the one or more geographical locations; and
(iii) frequency of the events at the one or more geographical locations;
identify a set of the financial services to provide at one of the one or more geographical locations based on an event type at each of the one or more locations, including determining a first set of the financial services when the event type is a payday for employees of a business at the one of the one or more locations, and including determining a second set of financial services when the event type is a sporting event at the one of the one or more locations, the first set and the second set being different from each other;
identify a set of technologies needed to implement the identified set of financial services at the one of the one or more geographical locations, the set of technologies including at least one of checking cashing technology and cash dispensing technology;
configure the autonomous vehicle to include the set of technologies identified as needed at the one of the one or more geographical locations;
determine a date and time for when the autonomous vehicle is needed at the one of the one or more geographical locations; and
autonomously drive the autonomous vehicle that is equipped with the identified set of technologies to arrive at the one of the one or more of the geographical locations at the date and time for when the autonomous vehicle is needed at the one of the one or more geographical locations.
